(19) United States
(12) Patent Application Publication
(10) Pub. No.: US 2013/0257897 A1
(43) Pub. Date: Oct. 3, 2013

(54) DISPLAY APPARATUS

(71) Applicants: Jeong-Young KIM, Yecheon-eup (KR); BumJin Kim, Cheonan-si (KR); Jinkyu Park, Asan-si (KR)

(72) Inventors: Jeong-Young KIM, Yecheon-eup (KR); BumJin Kim, Cheonan-si (KR); Jinkyu Park, Asan-si (KR)

(73) Assignee: Samsung Display Co., Ltd., Yongin-City (KR)

(21) Appl. No.: 13/601,525

(22) Filed: Aug. 31, 2012

(30) Foreign Application Priority Data
Mar. 28, 2012 (KR) 10-2012-0031863

(51) Int. Cl. G09G 5/02

(52) U.S. Cl. 345/596

(57) ABSTRACT

A display apparatus including an image signal controller, a dither memory, and a display panel. The display panel includes a dither block including pixels displaying an image in response to a dither image signal. The dither memory stores a dither set corresponding to a dither level. The dither set includes dither patterns. Each dither pattern determines that a corresponding pixel is a dither pixel that is to be dithered and a polarity of the dither pixel. A combined matrix, obtained by adding respective dither polarity matrices of the dither patterns, is zero. Thus, although the same image is displayed for a long time, an after-image caused by accumulation of the polarity may be prevented.

### CROSS-REFERENCE TO RELATED APPLICATION

This U.S. non-provisional patent application claims priority under 35 U.S.C. §119 of Korean Patent Application No. 10-2012-0031863, filed on Mar. 28, 2012, in the Korean Intellectual Property Office, which is incorporated herein by reference for all purposes as if fully set forth herein.

### BACKGROUND

1. Field

Exemplary embodiments of the invention relate to a display apparatus having improved display quality.

2. Discussion of the Background

In general, a display apparatus includes a display panel and a panel diver. The display panel includes a first display substrate, a second display substrate facing the first display substrate, and a liquid crystal layer disposed between the first display substrate and the second substrate. One of the first and second display substrates includes a plurality of gate lines and a plurality of data lines. The panel driver includes a gate driver that applies a gate signal to the gate lines, a data driver that applies an image data voltage to the data lines, and a signal controller that controls the gate driver and the data driver.

In order to improve display quality of the display apparatus, the signal controller applies dither patterns to an image signal received from an external source and outputs a dither image signal. The dither patterns determine which pixels are to be dithered from among a plurality of pixels included in a dither block. However, the dithering process may cause horizontal or vertical lines to be seen on the display apparatus or may cause flickering, thereby reducing display quality of a display apparatus.

The above information disclosed in this Background section is only for enhancement of understanding of the background of the invention and therefore it may contain information that does not constitute prior art.

### SUMMARY

Accordingly, there is a need for an improved display apparatus that may obviate one or more of the above-mentioned problems or disadvantages. In particular, there is a need for a display apparatus that provides improved display quality.

In the following description, certain aspects and embodiments will become evident. It should be understood that these aspects and embodiments are merely exemplary, and the invention, in its broadest sense, could be practiced without having one or more features of these aspects and embodiments.

Embodiments of the inventive concept provide a display apparatus includes an image signal controller and a display panel. The image signal controller receives an image signal and generates a dither image signal based on the image signal. The display panel includes a dither block that displays an image in response to the dither image signal, and the dither block includes a plurality of pixels that are driven by polarity inversion. The image signal controller determines a dither level based on the image signal and selects a dither set corresponding to the dither level. The dither set includes a plurality of dither patterns. A dither polarity matrix corresponds to each pixel of a dither pattern. Each element of the dither polarity matrix indicates whether a corresponding pixel is a dither pixel that is to be dithered and indicates a polarity of the dither pixel. A combined matrix obtained by adding respective dither polarity matrices of the dither patterns is defined by the image signal controller, and the dither set is repeated in a unit of a frame period. A total combined matrix obtained by adding N matrices (N is a nature number) to each other is zero after frames corresponding to N times of the frame period.

According to the above, since the combined matrix or the total combined matrix is zero, the occurrence of an after-image, which is caused by an accumulation of the polarity, may be prevented.

In addition, the size of the dither memory may be reduced.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is a block diagram showing a display apparatus according to a first exemplary embodiment of the present invention;

FIG. 2 is an equivalent circuit diagram of one pixel shown in FIG. 1;

FIG. 3 is a block diagram showing a signal controller shown in FIG. 1;

FIG. 4 is a block diagram showing a method of reading out a dither pattern from a dither memory shown in FIG. 1, using an image signal controller shown in FIG. 3;

FIGS. 5A and 5B are tables of explaining dither sets of first through eighth dither patterns corresponding to dither levels;

FIGS. 6A through 6D are tables explaining a process of setting second dither patterns;

FIG. 7 is a table of explaining a process of setting dither patterns included in one dither set shown in FIGS. 5A and 5B;

FIG. 8 is a table of explaining dither sets respectively corresponding to dither levels according to an exemplary embodiment of the present invention;

FIG. 9 is a block diagram showing an image signal controller according to an exemplary embodiment of the present invention;

FIG. 10 is a timing diagram showing a count signal;

FIGS. 11A and 11B are tables of explaining a process of changing an arrangement order of dither pixels included in dither patterns every other frame, by using the image signal controller shown in FIG. 9; and

FIG. 12 is table explaining a process of setting dither patterns included in two dither sets corresponding to each dither level.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

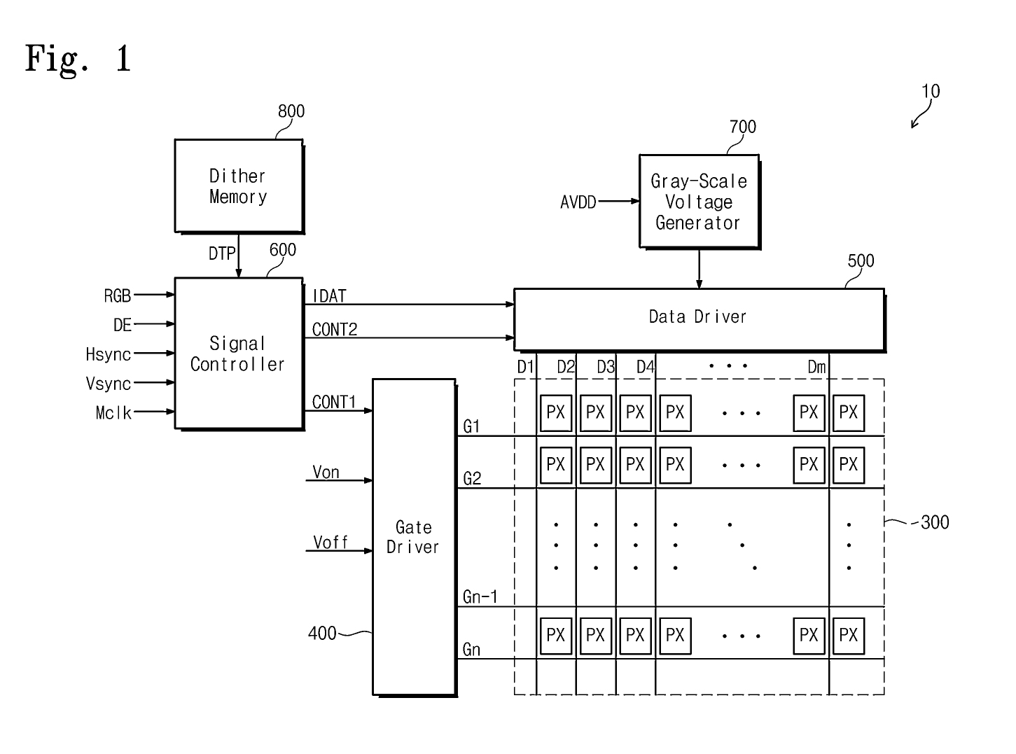

FIG. 1 is a block diagram showing a display apparatus according to a first exemplary embodiment of the present invention. Referring to FIG. 1, a display apparatus 10 includes a display panel 300, a signal controller 600, a dither memory 800, a gate driver 400, a data driver 500, and a gray-scale voltage generator 700.

The signal controller 600 receives an original image signal RGB and outputs a dither image signal IDAT. In addition, the signal controller 600 receives control signals, such as a data enable signal DE, a horizontal synchronization signal Hsync, a vertical synchronization signal Vsync, a main clock signal Mclk, etc., from an external device (not shown) and generates a gate control CONT1 and a data control signal CONT2. The gate control signal CONT1 is used to control an operation of the gate driver 400 and the data control signal CONT2 is used to control an operation of the data driver 500.

The display panel 300 includes a plurality of gate lines G1 to Gn, a plurality of data lines D1 to Dm, and a plurality of pixels PX. The gate lines G1 to Gn are extended in a row direction and the data lines D1 to Dm are extended in a column direction. The gate lines G1 to Gn are insulated from the data lines D1 to Dm while crossing the data lines D1 to Dm. The pixels PX are arranged in a matrix form. The pixels PX display an image in response to an image data voltage.

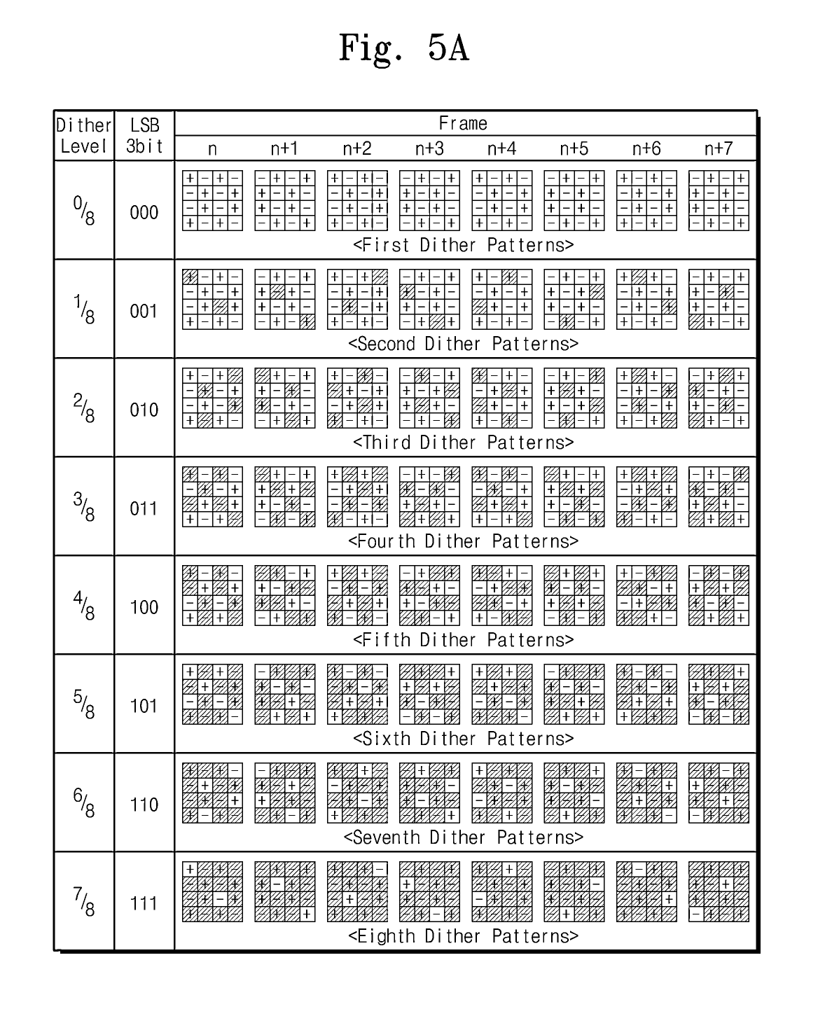

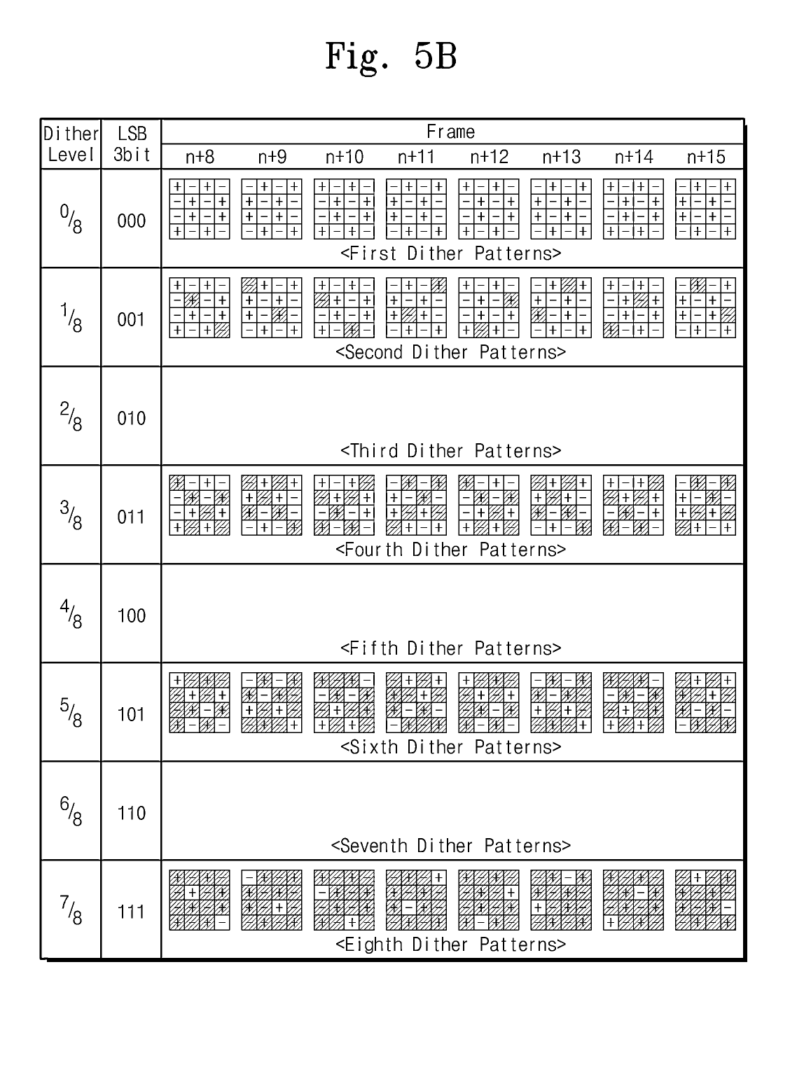

In addition, the display panel 300 includes dither blocks (not shown) that display the image in response to the dither image signal IDAT. Each dither block is a basic unit to which a dither pattern is applied. The dither pattern may be, for example, applied to pixels arranged in a matrix of four rows by four columns (refer to FIGS. 5A and 5B). Each dither block includes pixels PX, each having a polarity inverted at every frame.

The dither memory 800 stores a dither set corresponding to a dither level in a look-up table. The dither set includes a plurality of dither patterns DTP. The signal controller 600 reads out the dither patterns DTP from the dither memory 800 and applies the dither patterns DTP to the original image signal RGB, so as to output the dither image signal IDAT.

The gate driver 400 applies a gate signal to the gate lines G1 to Gn in response to the gate control signal CONT1 from the signal controller 600. The gate signal includes a gate-on voltage Von and a gate-off voltage Voff provided from a gate on/off voltage generator (not shown).

The data driver 500 receives the data control signal CONT2 from the signal controller 600 and applies the image data voltage corresponding to the dither image signal IDAT to the data lines D1 to Dm, in response to the data control signal CONT2.

The gray-scale voltage generator 700 applies the image data voltage obtained by voltage-dividing a driving voltage AVDD to the data driver 500, in accordance with the gray-scale of the dither image signal IDAT. The gray-scale voltage generator 700 includes a plurality of resistors connected between a node applied with the driving voltage AVDD and a ground voltage in series. The gray-scale voltage generator 700 voltage-divides the driving voltage AVDD to generate a plurality of gray-scale voltages. A circuit configuration of the gray-scale voltage generator 700 is not be limited to the above-mentioned configuration.

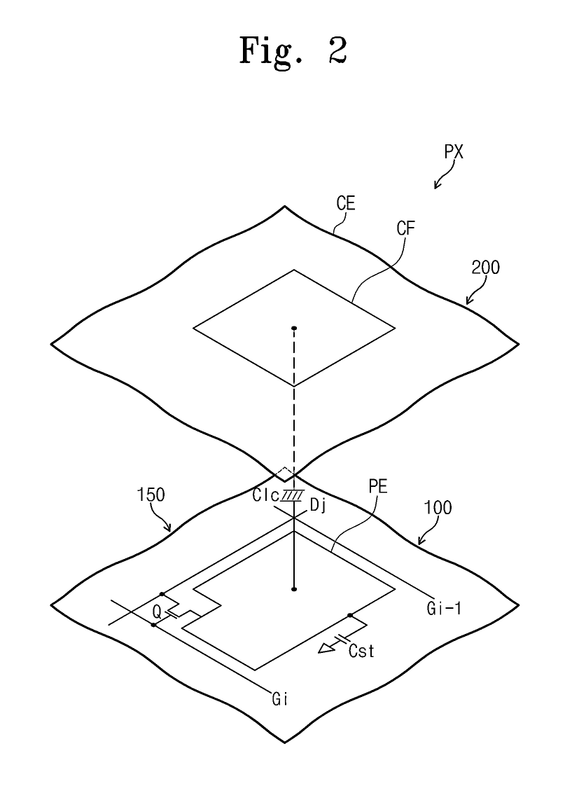

FIG. 2 is an equivalent circuit diagram of one pixel shown in FIG. 1. Referring to FIG. 2, a pixel PX connected to an i-th gate line Gi (i=1 to n) and a j-th data line Dj (j=1 to m) includes a switching device Q connected to the i-th gate line Gi and the j-th data line Dj, a liquid crystal capacitor Clc connected to the switching device Q, and a storage capacitor Cst connected to the switching device Q. The liquid crystal capacitor Clc is configured to include a pixel electrode PE of the first display substrate 100, a common electrode CE of the second display substrate 200, and liquid crystal molecules 150 interposed between the pixel electrode PE and the common electrode CE. When the switching device Q is turned on, the image data voltage applied to the j-th data line Di may be applied to the pixel electrode PE. The liquid crystal capacitor Clc is charged with a voltage difference between the common voltage Vcom applied to the common electrode CE and the image data voltage applied to the pixel electrode PE.

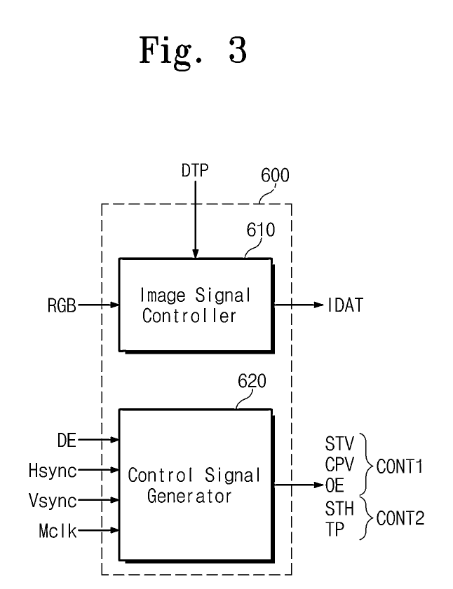

FIG. 3 is a block diagram showing a signal controller shown in FIG. 1. Referring to FIGS. 1 and 3, the signal controller 600 includes an image signal controller 610 and a control signal generator 620.

The image signal controller 610 receives the original image signal RGB. The image signal controller 610 reads the dither patterns DTP from the dither memory 800 and applies the dither image signal IDAT, which is generated using the read dither patterns DTP and the original image signal RGB, to the data driver 500.

The number of bits of the original image signal RGB may be a first number of bits, and the number of bits of the dither image signal IDAT may be a second number of bits which is less than the first number of bits. In addition, the number of bits of the image data voltage output from the grays-scale voltage generator 700 may be the second number of bits.

The control signal generator 620 receives the control signals DE, Hsync, Vsync, and Mclk and generates the gate control signal CONT1 and the data control signal CONT2. The data enable signal DE is maintained in a high level during a period in which the original image signal RGB is input, to indicate that the signal provided from a graphic controller (not shown) is the original image signal RGB. The vertical synchronization signal Vsync indicates the start of one frame, the horizontal synchronization signal Hsync is used to distinguish the gate lines from each other, and the main clock signal Mclk is used as a synchronization signal to synchronize signals used to drive the display apparatus 10.

The gate control signal CONT1 is used to control the operation of the gate driver 400. The gate control signal CONT1 includes a vertical start signal STV that starts an operation of the gate driver 400, a gate clock signal CPV that determines an output timing of the gate-on voltage, and an output enable signal OE that determines a pulse width of the gate-on voltage.

The data control signal CONT2 is used to control the operation of the data driver 500. The data control signal CONT2 includes a horizontal start signal STH that starts an operation of the data driver 500 and an output indicating signal TP that indicates an output of the image data voltage.

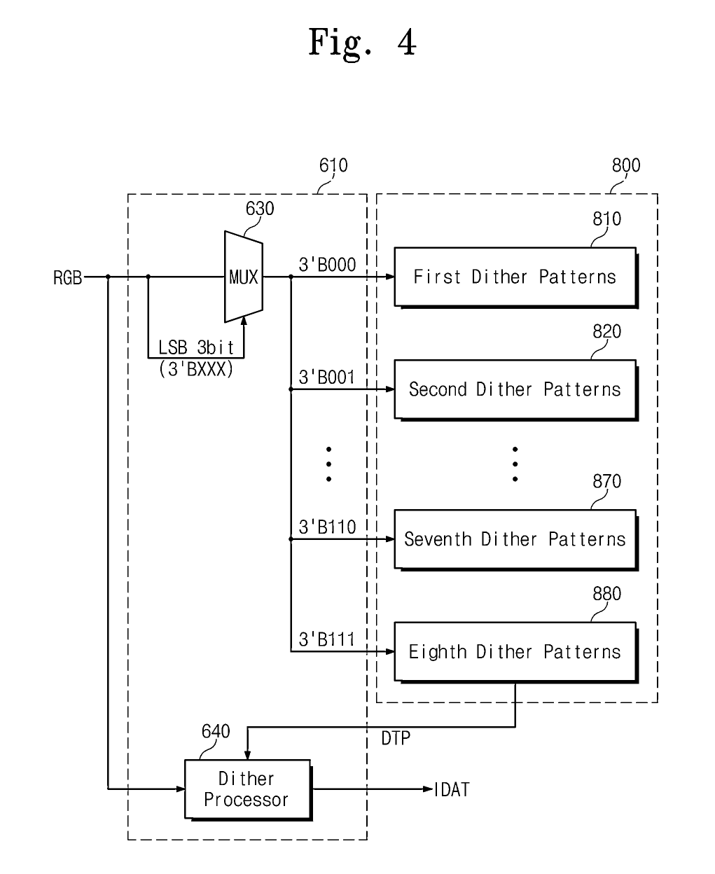

FIG. 4 is a block diagram showing a method of reading a dither pattern from a dither memory shown in FIG. 1, using the image signal controller 610 shown in FIG. 3. Referring to FIG. 4, the image signal controller 610 may determine the dither level with reference to least significant bits (LSBs) of the original image signal RGB. When the dither level is determined, the dither set corresponding to the dither level is determined by the image signal controller 610. The image control signal 610 may read the dither patterns included in the dither set from the dither memory 800. Here, the LSBs of the original image signal RGB denote the least significant digits of the original image signal RGB. In FIG. 4, the LSBs of the original image signal RGB include 3 LSBs (the least significant 3 bits).

The image signal controller 610 includes a multiplexer 630 and a dither processor 640. The multiplexer 630 reads the dither patterns included in the dither set corresponding to the determined dither level from among the dither sets stored in the dither memory 800, by using the LSB of the original image signal RGB as a selection signal. In FIG. 4, first through eighth dither patterns 810 to 880 respectively indicate dither sets, e.g., dither patterns corresponding to each dither level.

For instance, the multiplexer 630 reads the first dither pattern 810 when the LSBs are 000. The multiplexer 630 reads out the second dither pattern 820 when the LSBs are 001. The multiplexer 630 reads out the third dither pattern (not shown) when the LSBs are 010. The multiplexer 630 reads out the fourth dither pattern (not shown) when the LSBs are 011. The multiplexer 630 reads out the fifth dither pattern (not shown) when the LSBs are 100. The multiplexer 630 reads out the sixth dither pattern (not shown) when the LSBs are 101. The multiplexer 630 reads out the seventh dither pattern 870 when the LSBs are 110. The multiplexer 630 reads out the eighth pattern 880 when the LSBs are 111.

The dither processor 640 receives one of the first to eighth dither patterns 810 to 880 and dithers the original image signal RGB and outputs the dither image signal IDAT. Although the dither image signal IDAT has a smaller number of bits than the original image signal RGB, more gray levels may be expressed in comparison with when the dither patterns DTP are not applied.

FIGS. 5A and 5B are tables showing dither sets of first to eighth dither patterns corresponding to each dither level, according to the first exemplary embodiment of the present invention. Hereinafter, the dither image signal IDAT including image information determined by the LSB of the original image signal RGB will be described in detail with reference to FIGS. 5A and 5B.

Referring to FIGS. 5A and 5B, when the LSB are 3-digits, 2³ dither levels may be set. The 3 LSB combinations ‘000’, ‘001’, ‘010’, ‘011’, ‘100’, ‘101’, ‘110’, and ‘111’ correspond to dither levels of ‘0/8’, ‘1/8’, 2/8′, ‘3/8’, ‘4/8’, ‘5/8’, 6/8’, and ‘7/8’, respectively.

The number of dither pixels in each dither block is determined by the dither levels. Here, the dither pixels refer to pixels to be dithered, from among the pixels included in each dither block. The dither pixels may be driven by data obtained by adding (or subtracting) one to data of upper bits corresponding to dither pixels, which are bits of the original image signal excluding the 3 LSBs. That is, an image data voltage having a value that corresponds to the data obtained by adding (or subtracting) one to the data of the upper bits of the original image signal RGB, may be applied to pixels that are to be dithered. In addition, an image data voltage having a value that corresponds to the data of the upper bits of the original image signal RGB, may be applied to pixels that are not dithered.

The number of dither pixels included in each dither block may be 0, 2, 4, 6, 8, 10, 12, and 14 according to the dither levels of ‘0/8,’ ‘1/8,’ ‘2/8,’ ‘3/8,’ ‘4/8,’ ‘5/8,’ ‘6/8,’ and ‘7/8,’ respectively. Referring to each dither pattern shown in FIGS. 5A and 5B, pixels, which are to be dithered, from among pixels included in each dither block are indicated by oblique lines.

Specifically, when the 3 LSBs of the original image signal RGB are ‘000’, 16 adjacent pixels may all be driven by the image data voltage that corresponds to the data of the upper bits of the original image signal RGB. When the 3 LSBs of the original image signal RGB are ‘001’, two of the 16 adjacent pixels may be driven by the image data voltage that corresponds to the data obtained by adding (or subtracting) one to the data of the upper bits of the original image signal RGB. Thus, the 16 pixels may display, on average, an image whose 3 LSBs are ‘001’.

Likewise, four of the 16 adjacent pixels are dithered when the 3 LSBs of the original image signal RGB are ‘010.’ Six of the 16 adjacent pixels are dithered when the 3 LSBs of the original image signal RGB are ‘011.’ Eight of the 16 adjacent pixels are dithered when the 3 LSBs of the original image signal RGB are ‘100.’ Ten of the 16 adjacent pixels are dithered when the 3 LSBs of the original image signal RGB are ‘101.’ Twelve of the 16 adjacent pixels are dithered when the 3 LSBs of the original image signal RGB are ‘110.’ Fourteen of the 16 adjacent pixels are dithered when the 3 LSBs of the original image signal RGB are ‘111.’ The dithering may include driving the dithered pixels using the image data voltage which corresponds to the data obtained by adding one to the data of the upper bits of the original image signal RGB. Thus, the 16 pixels may display, on average, an image corresponding to each dither level.

When the dither level is determined by 3 LSBs, the dither patterns corresponding to the determined dither level are sequentially applied to pixels of the dither block during successive frames. A dither set corresponding to a dither level may include sixteen or eight dither patterns. In FIGS. 5A and 5B, the sixteen or eight dither patterns are sequentially applied to the (n)^{th} through (n+15)^{th} frames for each dither level. The eight dither patterns may be equally applied to the (n)^{th} through (n+7)^{th} frames and the (n+8)^{th} to (n+15)^{th} frames. In FIGS. 5A and 5B, only the eight dither patterns applied to the (n)^{th} to (n+7)^{th} have been shown and the eight dither patterns applied to the (n+8)^{th} to (n+15)^{th} frames have been omitted.

Each dither set may be repeated in a unit of a first frame period configured to include plural frames. When the bit number of the LSBs is K (K is a natural number), the number of the frames included in the first frame period is 2^{K+1}. In FIGS. 5A and 5B, the LSBs include 3 bits, and the first frame period includes 16 frames, from the (n)^{th} through (n+15)^{th} frames.

Each dither set includes dither patterns having an equal number of dither pixels. At least two dither patterns included in each dither set may include the dither pixels positioned at the same position.

As shown in FIGS. 5A and 5B, in the dither set configured to include 16 dither patterns, (corresponding dither levels 1/8, 3/8, 5/8, and 7/8) the positions of the dither pixels included in the dither patterns applied to the (n)^{th} frames are the same as the positions of the dither pixels included in the dither patterns applied to the (n+9)^{th} frames.

The positions of the dither pixels included in the dither patterns applied to the (n+1)^{th} frame are the same as the positions of the dither pixels included in the dither patterns applied to the (n+8)^{th} frame. The positions of the dither pixels included in the dither patterns applied to the (n+2)^{th} frame are the same as the positions of the dither pixels included in the dither patterns applied to the (n+11)^{th} frame. The positions of the dither pixels included in the dither patterns applied to the (n+3)^{th} frame are the same as the positions of the dither pixels included in the dither patterns applied to the (n+10)^{th} frame. The positions of the dither pixels included in the dither patterns applied to the (n+4)^{th} frame are the same as the positions of the dither pixels included in the dither patterns applied to the (n+13)^{th} frame. The positions of the dither pixels included in the dither patterns applied to the (n+5)^{th} frame are the same as the positions of the dither pixels included in the dither patterns applied to the (n+12)^{th} frame. The positions of the dither pixels included in the dither patterns applied to the (n+6)^{th} frame are the same as the positions of the dither pixels included in the dither patterns applied to the (n+15)^{th} frame. The positions of the dither pixels included in the dither patterns applied to the (n+7)^{th} frame are the same as the positions of the dither pixels included in the dither patterns applied to the (n+14)^{th} frame.

In addition, as shown in FIGS. 5A and 5B, in the dither set configured to include 8 dither patterns, (corresponding dither levels 2/8, 4/8, and 6/8), the positions of the dither pixels included in the dither patterns applied to the (n)^{th} frame are the same as the positions of the dither pixels included in the dither patterns applied to the (n+5)^{th} frame. The positions of the dither pixels included in the dither patterns applied to the (n+1)^{th} frame are the same as the positions of the dither pixels included in the dither patterns applied to the (n+4)^{th} frame. The positions of the dither pixels included in the dither patterns applied to the (n+2)^{th} frame are the same as the positions of the dither pixels included in the dither patterns applied to the (n+7)^{th} frame. The positions of the dither pixels included in the dither patterns applied to the (n+3)^{th} frame are the same as the positions of the dither pixels included in the dither patterns applied to the (n+6)^{th} frame.

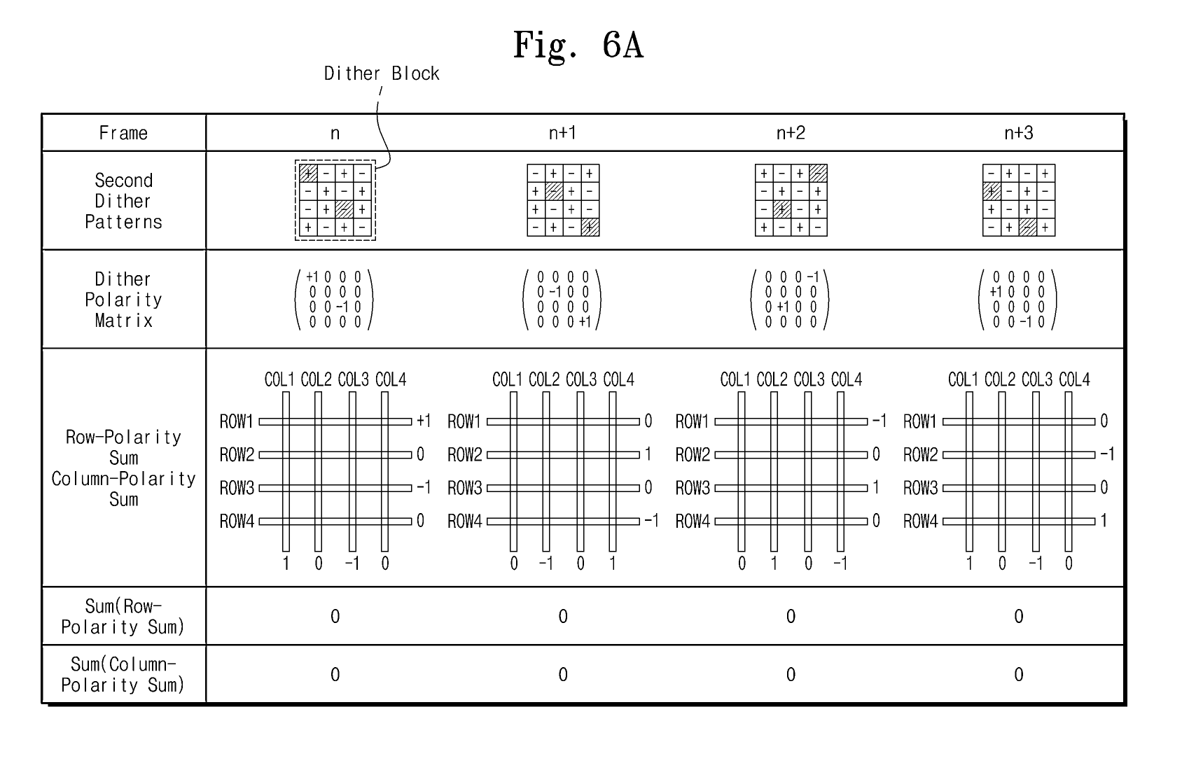

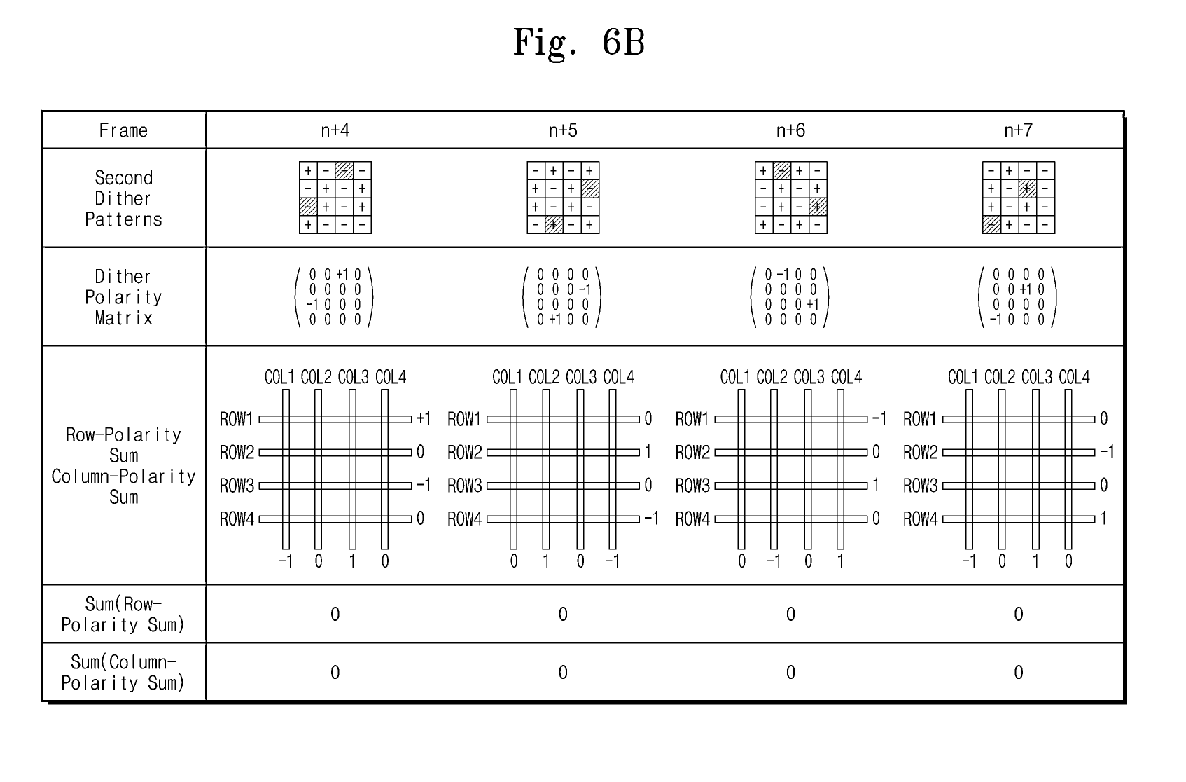

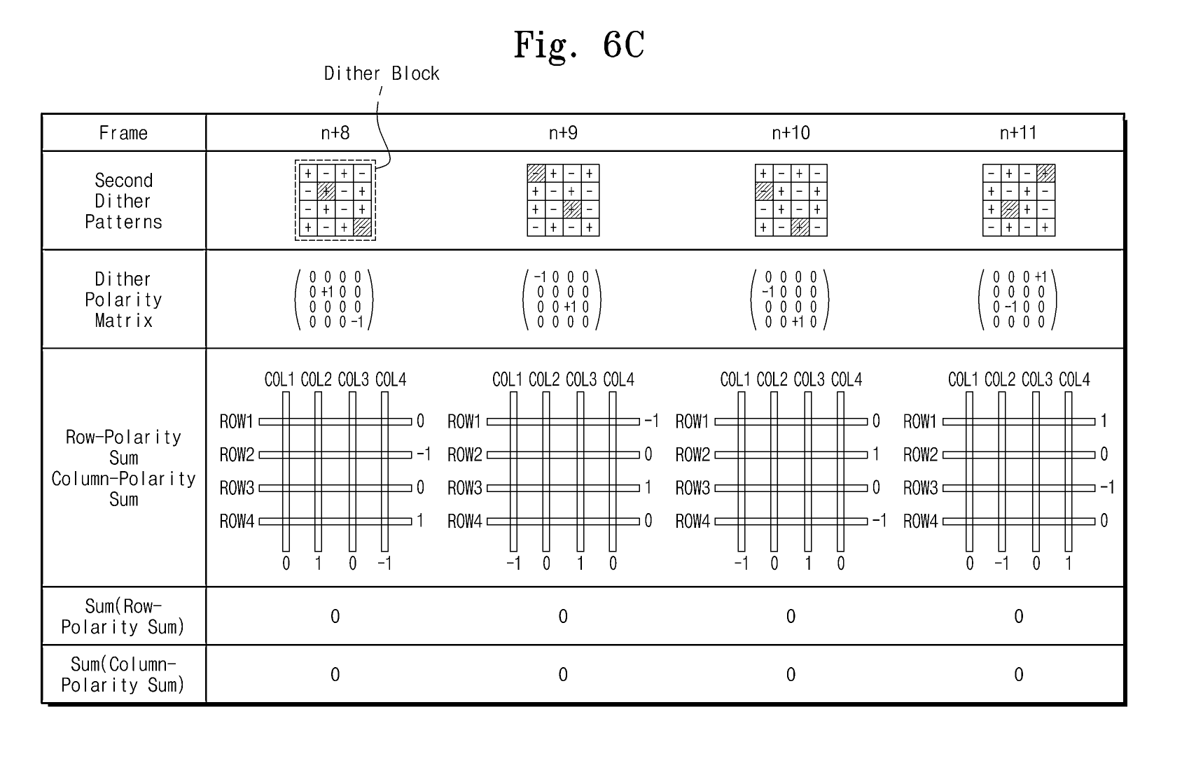

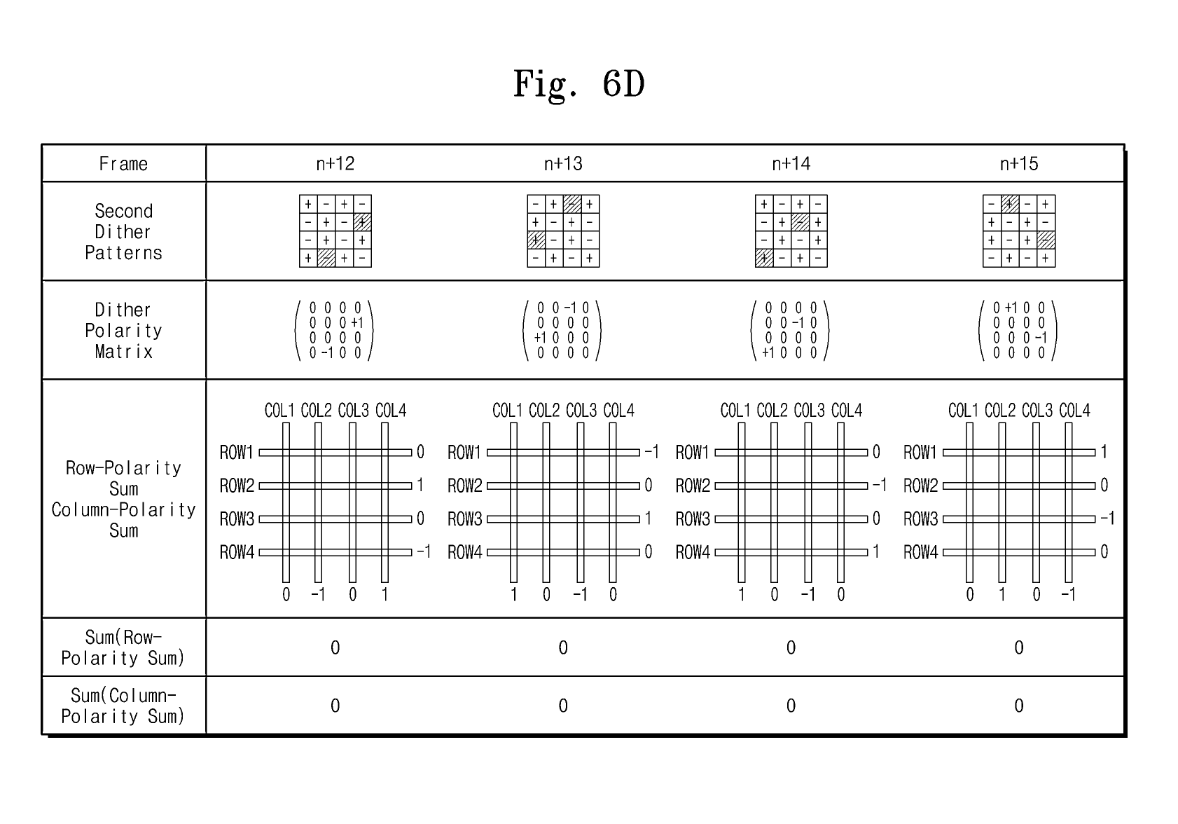

Hereinafter, a process of setting each dither pattern included in each dither set will now be described in more detail with reference to FIGS. 6A through 6D. FIGS. 6A through 6D are tables explaining a process of setting each dither pattern shown in FIGS. 5A and 5B, e.g., the second dither patterns. In FIGS. 6A through 6D, each dither block includes a plurality of pixels arranged in a 4×4 matrix.

Referring to FIGS. 6A through 6D, the polarities of pixels included in each dither block may be inverted every frame and driven accordingly. In FIGS. 6A through 6D, the ‘+’ and ‘−’ signs indicate when that each pixel is driven with a positive or negative polarity. It can be understood that the polarity of each pixel is inverted per frame, such that each pixel is driven with a different polarity in each of the successive (n)^{th} through (n+15)^{th} frame.

Each dither pattern may be set such that a corresponding dither block includes equal numbers of positive-polarity dither pixels and negative-polarity dither pixels. It can be understood from each dither pattern of FIGS. 6A through 6D that the number of dither pixels driven with a positive polarity, i.e., positive-polarity dither pixels, is equal to the number of dither pixels driven with a negative polarity, i.e., negative-polarity dither pixels. In each dither pattern of FIGS. 6A through 6D applied to each of the (n)^{th} through (n+15)^{th} frames, there is one positive-polarity dither pixel and one negative-polarity dither pixel.

Each dither pattern may be set such that the sum of elements of a corresponding dither polarity matrix is zero. Each element of the dither polarity matrix corresponds to each pixel in a dither block. In addition, each element of the dither polarity matrix indicates whether a corresponding pixel in the dither block is a dither pixel that is to be dithered and indicates the polarity of the dither pixel. In each dither polarity matrix shown in FIGS. 6A through 6D, ‘0’ indicates a pixel that is not to be dithered, ‘+1’ indicates a positive-polarity dither pixel, and ‘−1’ indicates a negative-polarity dither pixel. As shown in each dither polarity matrix of FIGS. 6A through 6D, each dither pattern may be set such that the sum of elements of a corresponding dither polarity matrix is zero.

In addition, each dither pattern may be set such that at least one of the sum of row-polarity sums and the sum of column-polarity sums is zero. Each row-polarity sum is the sum of elements in each row of the dither polarity matrix, and each column-polarity sum is the sum of elements in each column of the dither polarity matrix.

For example, in a dither polarity matrix corresponding to a dither pattern that is applied to the (n)^{th} frame of FIG. 6A, the row-polarity sum of a first row is +1, the row-polarity sum of a second row is 0, the row-polarity sum of a third row is −1, and the row-polarity sum of a fourth row is 0. Accordingly, the sum of the row-polarity sums of the first through fourth rows is zero. In addition, the column-polarity sum of a first column is +1, the column-polarity sum of a second column is 0, the column-polarity sum of a third column is −1, and the column-polarity sum of a fourth column is 0. Accordingly, the sum of the column-polarity sums of the first through fourth columns is zero. As described above, each dither pattern may be set such that at least one of the sum of row-polarity sums of the dither polarity matrix and the sum of column-polarity sums of the dither polarity matrix is zero. Although the process of setting dither patterns that are applied to each of the (n+1)^{th} through (n+15)^{th} frames of FIGS. 6A through 6D is not described for simplicity, the above description of the process of setting the dither pattern applied to the (n)^{th} frame may also be applied to the (n+1)^{th} through (n+15)^{th} frames.

Further, each dither pattern may also be set such that each row-polarity sum and each column-polarity sum is zero. For example, referring to dither polarity matrices (not shown) corresponding to the dither patterns of FIGS. 5A and 5B, which are applied to the (n+1)^{th}, (n+3)^{th}, (n+8)^{th}, and (n+10)^{th} frames, respectively, each of the dither patterns is set such that each row-polarity sum and each column-polarity sum of a corresponding dither polarity matrix is zero.

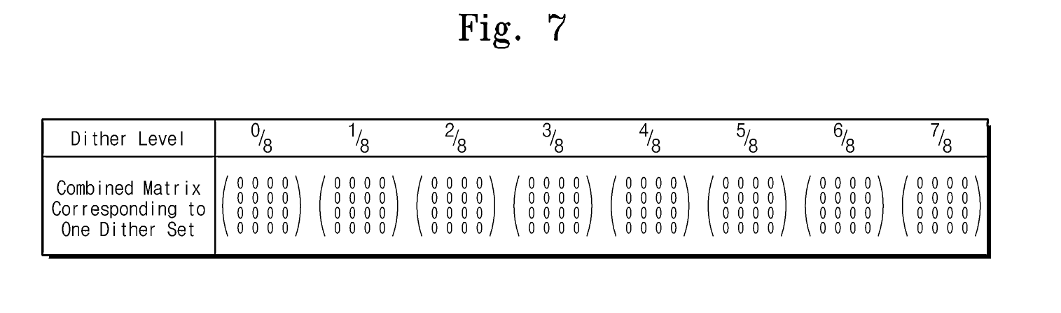

A process of setting the dither patterns included in the dither sets will be described with reference to FIG. 7. FIG. 7 is a table of explaining the process of setting the dither patterns included in one dither set, for each dither level shown in FIGS. 5A and 5B. The dither patterns included in the dither set may be set by using a combined matrix obtained by adding together the respective dither polarity matrices of the dither patterns of each dither level. FIG. 7 illustrates a combined matrix of one dither set corresponding to each dither level.

The combined matrix corresponding to one dither set with respect to each dither level may be a zero matrix. For example, in the case of the second dither patterns corresponding to the dither level ‘1/8’ and described above with reference to FIGS. 6A through 6D, the sum of the row-polarity and column-polarity sums of second dither patterns is zero. This may be applied to the first dither patterns corresponding to the dither level ‘0/8’ and to third through eighth dither patterns respectively corresponding to the dither level ‘2/8’ through ‘7/8’.

In the first exemplary embodiment, since the combined matrix is zero, the dither patterns may be set such that the sum of row-polarity sums of elements in each row of the combined matrix and the sum of column-polarity sums of elements in each column of the combined matrix are zero. In addition, the dither patterns may be set such that each row-polarity sum of the combined matrix and each column-polarity sum of the combined matrix are zero.

In the first exemplary embodiment, the LSBs of the original image signal RGB are 3 bits, but the present invention is not limited to 3 bits. That is, the LSBs of the original image signal RGB may be K (K is a natural number) bits, i.e., 4 bits. In the case that the LSBs are 4 bits, 2⁴ dither levels (i.e., 16 dither levels) may be set. In addition, each dither set may be configured to include 8 or 16 dither patterns. Further, 16 frames may be included in the first frame period. In the case that the LSBs are 4 bits, a combined matrix corresponding to one dither set with respect to each dither level may be zero.

In a conventional display apparatus, a combined matrix is not zero, i.e., at least one of elements in the combined matrix has a positive or negative polarity. Accordingly, display defects, such as noise, flicker, etc., appear on images. Particularly, when the display apparatus displays the same image for a long time, an after-image occurs due to accumulation of the positive or negative polarity.

According to the display apparatus described above, since the combined matrix is zero, the occurrence of the after-image, which is caused by the accumulation of the polarity, may be prevented.

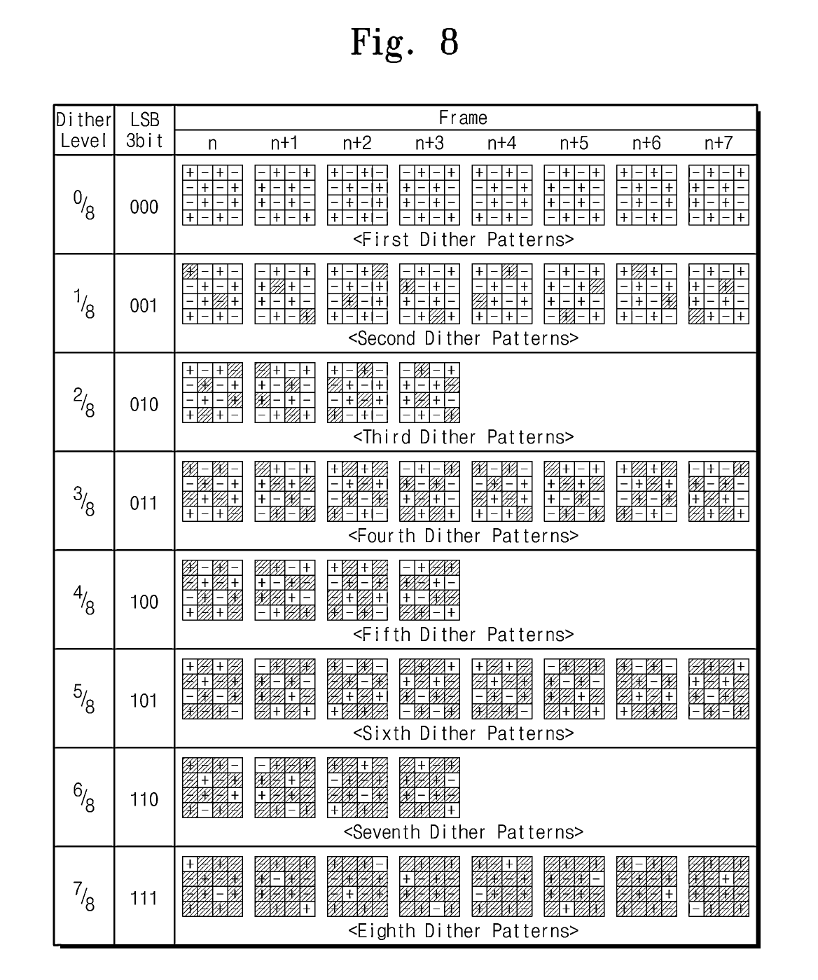

Hereinafter, a display apparatus, according to an exemplary embodiment of the present invention, will be described with reference to FIGS. 8 through 12. In the second exemplary embodiment, different configurations from those of the first exemplary embodiment will mainly be described, and same configuration from those of the first exemplary embodiment will be omitted.

FIG. 8 is a table showing dither sets corresponding to each dither level. When the dither level is determined by 3 LSBs, the dither patterns corresponding to the determined dither level are sequentially applied to successive frames of each dither block. In FIG. 8, eight or four dither patterns are sequentially applied to the (n)^{th} through (n+7)^{th} frames for each dither level. The four dither patterns may be equally applied to the (n)^{th} through (n+3)^{th} frames and the (n+4)^{th} through (n+7)^{th} frames. In FIG. 8, only the four dither patterns applied to the (n)^{th} through (n+3)^{th} frames have been shown and the four dither patterns applied to the (n+4)^{th} through (n+7)^{th} frames have been omitted.

Each dither set may be repeated in the unit of second frame configured to include plural frames. When the bit number of the LSBs is K, the number of the frames included in the second frame period may be 2^{K}. In FIG. 8, the LSBs include 3 bits, and the second frame period includes 8 frames. An arrangement order of the dither pixels included in each dither pattern may be changed in every second frame period. The dither patterns included in each dither set include an equal number of dither pixels, but the dither pixels are positioned at different positions from each other.

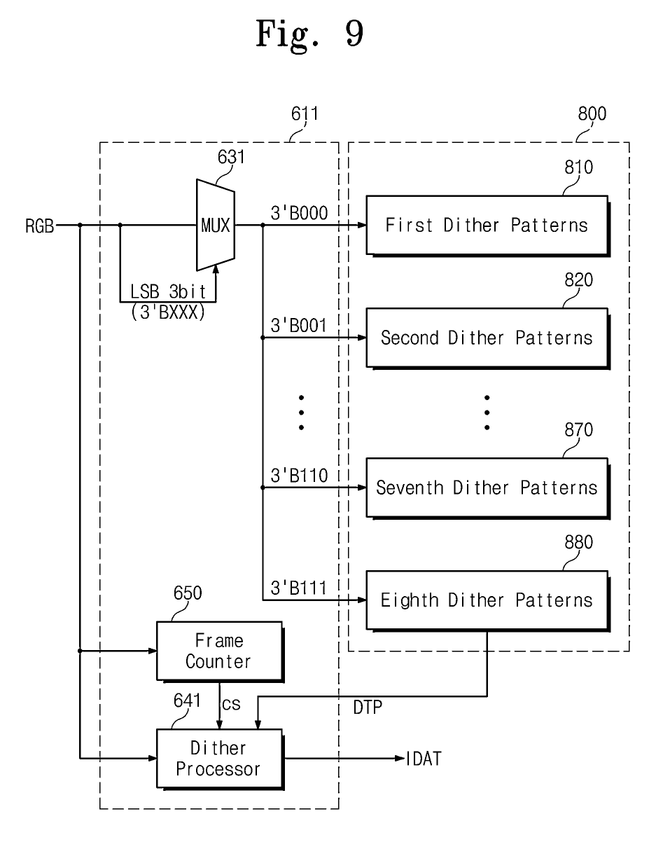

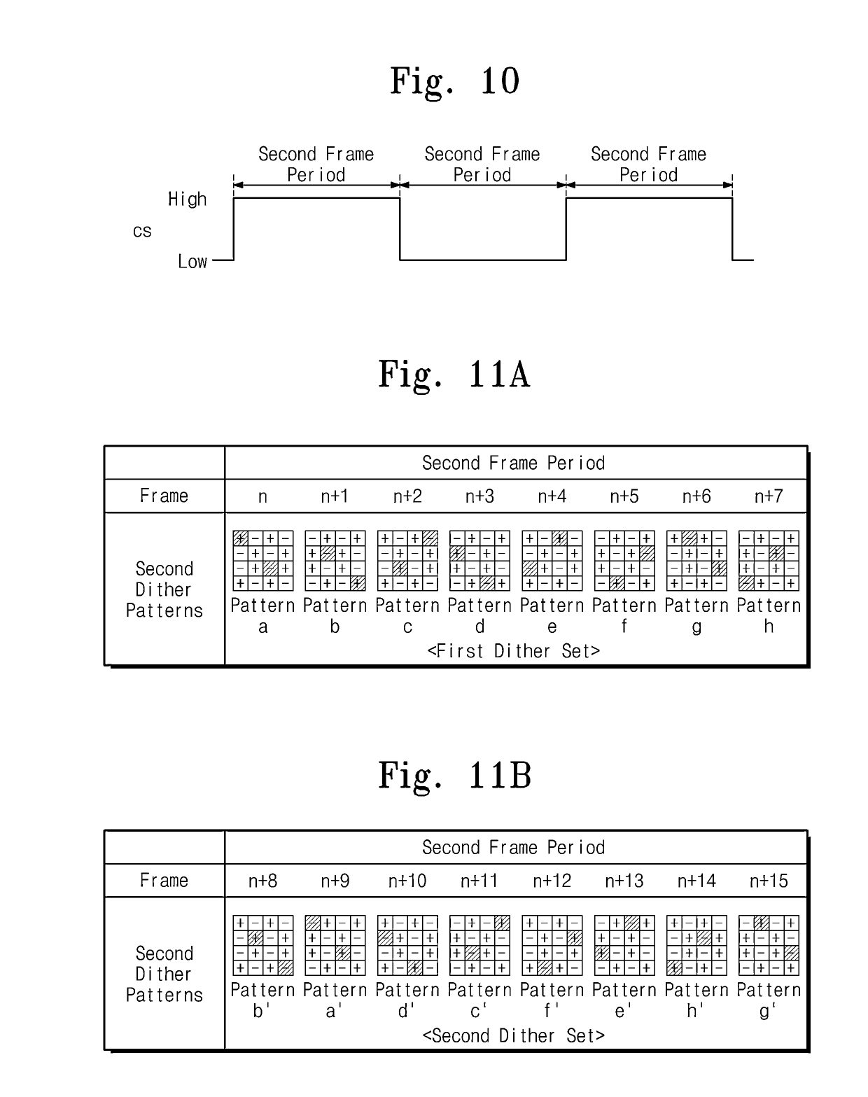

FIG. 9 is a block diagram showing an image signal controller according to an exemplary embodiment of the present invention, and FIG. 10 is a timing diagram showing a count signal. Referring to FIG. 9, an image signal controller 611 includes a multiplexer 631, a dither processor 641, and a frame counter 650.

The frame counter 650 receives an original image signal RGB and counts the original image signal RGB in the unit of the second frame period. In addition, the frame counter 650 generates a count signal cs, which has a level varied at every second frame period, and applies the count signal cs to the dither processor 641.

The image signal controller 611 may change the arrangement order of the dither pixels included in each the dither patterns of one dither set, at every second frame period. In detail, the dither patterns may be arranged in the unit of two adjacent dither patterns, and the image signal controller 611 may change the positions of the dither pixels included in each of the two adjacent dither patterns at every second frame period.

Referring to FIG. 10, the count signal cs has a high or low level during the second frame period. The count signal cs may alternately have the high and low level at every second frame period.

FIGS. 11A and 11B are tables explaining a process of changing an arrangement order of dither pixels included in dither patterns of every second frame period, by using the image signal controller shown in FIG. 9. In FIGS. 11A and 11B, the arrangement order of the dither pixels included in the second dither pattern shown in FIG. 8 is changed in the at every second frame period.

Referring to FIGS. 9, 10, 11A, and 11B, the second dither patterns include patterns a to h, which respectively correspond to the (n)^{th} through (n+7)^{th} frames. The count signal cs may have the high lever or the low level during the (n)^{th} through (n+7)^{th} frames, but the high level of the count signal cs will be described as a representative example. The image signal controller 611 may sequentially apply the patterns a to h to the (n)^{th} through (n+7)^{th} frames, respectively, in response to the count signal cs having the high level.

The second dither patterns includes patterns a′ to h′, which respectively correspond to the (n+8)^{th} through (n+15)^{th} frames. The count signal cs has the low level during the (n+8)^{th} through (n+15)^{th} frames. The image signal controller 611 may sequentially apply the pattern b′, the pattern a′, the pattern d′, the pattern c′, the pattern f′, the pattern e′, the pattern g′, and the pattern h′ to h to the (n+8)^{th}, the (n+9)^{th}, the (n+10)^{th}, the (n+11)^{th}, the (n+12)^{th}, the (n+13)^{th}, the (n+14)^{th}, and (n+15)^{th} frames, respectively, in response to the count signal cs having the low level.

In this case, positions of the dither pixels in the pattern a are the same as the pattern a′ and a polarity of the dither block of the pattern a is opposite to that of the pattern a′. Similarly, positions of the dither pixels in the pattern b are the same as the pattern b′ and a polarity of the dither block of the pattern b is opposite to that of the pattern b′. Positions of the dither pixels in the pattern c are the same as the pattern c′ and a polarity of the dither block of the pattern c is opposite to that of the pattern c′. Positions of the dither pixels in the pattern d are the same as the pattern d′ and a polarity of the dither block of the pattern d is opposite to that of the pattern d′. Positions of the dither pixels in the pattern e are the same as the pattern e′ and a polarity of the dither block of the pattern e is opposite to that of the pattern e′. Positions of the dither pixels in the pattern f are the same as the pattern f′ and a polarity of the dither block of the pattern f is opposite to that of the pattern f′. Positions of the dither pixels in the pattern g are the same as the pattern g′ and a polarity of the dither block of the pattern g is opposite to that of the pattern g′. Positions of the dither pixels in the pattern h are the same as the pattern h′ and a polarity of the dither block of the pattern h is opposite to that of the pattern h′.

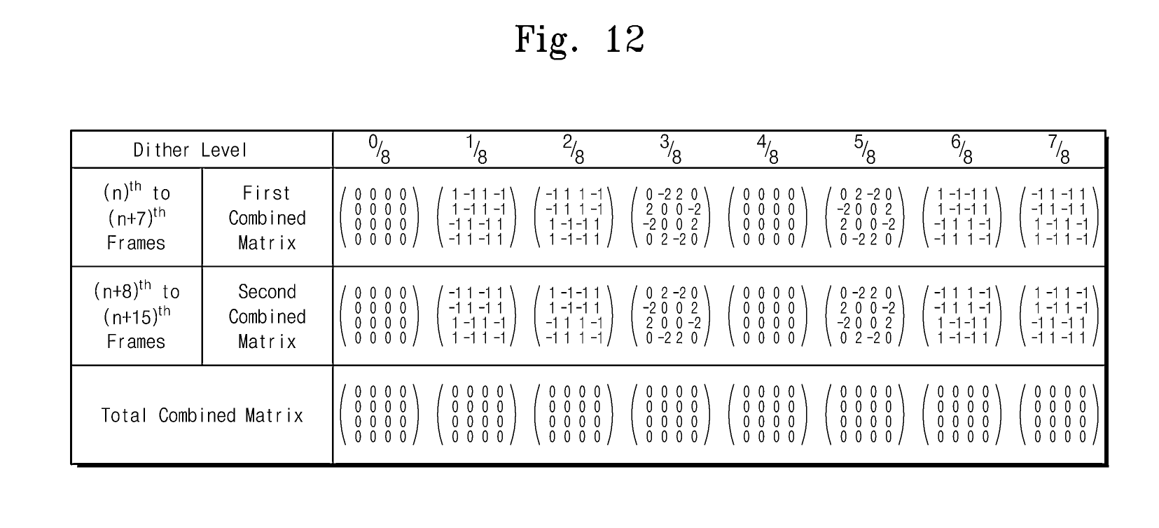

FIG. 12 is table of explaining a process of setting dither patterns included in each of two dither sets corresponding to each dither level. Specifically, the process of setting the dither patterns included in each dither set at every second frame period, by using the image signal controller 611, will be described with reference to FIGS. 11A, 11B, and 12.

The dither set for each dither level may include a first dither set and a second dither set. The first dither set includes the dither patterns respectively corresponding to the (n)^{th} through (n+7)^{th} frames, and the second dither set includes the dither patterns respectively corresponding to the (n+8)^{th} through (n+15)^{th} frames. The first dither set includes the pattern a to the pattern h, and the second dither set includes the pattern a′ to the pattern h′ in the case of the second dither patterns shown in FIGS. 11A and 11B.

In addition, a first combined matrix and a second combined matrix may be defined in each dither level. The first combined matrix is a matrix obtained by adding the dither polarity matrices of the dither patterns included in the first dither set to each other, and the second combined matrix is a matrix obtained by adding the dither polarity matrices of the dither patterns included in the second dither set to each other. FIG. 12 shows the first combined matrix and the second combined matrix of each dither level.

A total combined matrix obtained by adding the first combined matrix and the second combined matrix may be zero. For example, in the case of the second dither patterns corresponding to the dither level ‘1/8’ and described above with reference to FIGS. 11A through 11D, the total combined matrix obtained by adding the first combined matrix corresponding to the first dither set and the second combined matrix corresponding to the second dither set. Likewise, the total combined matrix of each dither level ‘0/8’, ‘2/8’, ‘3/8’, ‘4/8’, ‘5/8’, ‘6/8’, and ‘7/8’ may be zero.

In addition, at least one of the sum of row-polarity sums and the sum of column-polarity sums of the first combined matrix is zero. Each row-polarity sum is the sum of elements in each row of the first combined matrix, and each column-polarity sum is the sum of elements in each column of the first combined matrix. Similarly, at least one of the sum of row-polarity sums and the sum of column-polarity sums of the second combined matrix is zero. Each row-polarity sum is the sum of elements in each row of the second combined matrix, and each column-polarity sum is the sum of elements in each column of the second combined matrix.

In addition, each row-polarity sum and each column-polarity sum of the first combined matrix may be zero. Likewise, each row-polarity sum and each column-polarity sum of the second combined matrix may be zero.

In the second exemplary embodiment, LSBs of the original image signal RGB are 3 bits, but the LSBs are not limited to 3 bits. That is, the LSBs of the original image signal RGB may be K (K is a natural number) bits, i.e., 4 bits. In the case that the LSBs are 4 bits, 2⁴ dither levels (i.e., 16 dither levels) may be set. In addition, each dither set may be configured to include 4 or 8 dither patterns. Further, 8 frames may be included in the second frame period. In the case that the LSBs are 4 bits, a total combined matrix obtained by adding the first combined matrix and the second combined matrix may be zero.

According to the second exemplary embodiment, the number of the dither patterns included in one dither set corresponding to each dither level may be reduced to half of the number of the dither patterns described in the first exemplary embodiment. Therefore, the size of the memory included in the display apparatus according to the second exemplary embodiment may be reduced by half when compared with the size of the memory included in the display apparatus according to the first exemplary embodiment.

In addition, since the image signal controller 611 described in the second exemplary embodiment changes the arrangement order of the dither pixels included in the dither patterns for one dither set at every second frame period, display defects, such as noise, flicker, etc., may be prevented.

Hereinafter, a display apparatus according to an exemplary embodiment of the present invention will be described. The display apparatus has the same configuration as the display apparatus as described above, except for an operation of an image signal controller (not shown). Thus, the operation of the image signal controller will mainly be described.

The image signal controller (not shown) may randomly change an arrangement order of dither pixels included in each dither patterns of one dither set at every second frame period.

In the case of the randomly changed arrangement order, the total combined matrix corresponding to each dither level is a zero matrix, after two second frame periods. On the other hand, the time point at which the total combined matrix corresponding to each dither level becomes a zero matrix may not be specified. However, the total combined matrix may become zero after eight second frame periods with reference to the second dither patterns corresponding to the dither level ‘1/8’, i.e., the dither set including eight dither patterns.

Thus, as the number of frames of the original image signal applied to the image signal controller (not shown) according to the third exemplary embodiment increases, effects similar to those of the second exemplary embodiment may be obtained.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel comprising a dither block configured to display an image in response to a dither image signal, the dither block comprising pixels configured to be driven by polarity inversion during subsequent frames of an image; and
an image controller is configured to generate the dither image signal based on a received image signal by:
determining a dither level based on the received image signal;
selecting a dither set corresponding to the dither level, the dither set comprising dither patterns that each correspond to a dither polarity matrix, each element of the dither polarity matrix indicating whether a corresponding pixel of the dither block is a dither pixel that is to be dithered and indicates a polarity of each dither pixel during a corresponding frame of the image signal,
defining a combined matrix by adding together the dither polarity matrices; and
applying the dither set to the dither block at every frame period (including a plurality of frames),
wherein a total combined matrix obtained by adding N combined matrices is a zero matrix, after N times of the frame periods, wherein N is a natural number.

2. The display apparatus of claim 1, wherein the each element of the dither polarity matrix indicates each pixel that is not to be dithered as zero, indicates a polarity of the dither pixels having a positive polarity as +1, and indicates a polarity of the dither pixels having a negative polarity as −1.

3. The display apparatus of claim 2, wherein N is 1.

4. The display apparatus of claim 3, wherein the image signal comprises K least significant bits (LSBs), where K is a natural number, and the number of frames included in the frame period is 2^{K+1}.

5. The display apparatus of claim 4, wherein at least two of the dither patterns have the same pattern of dither pixels.

6. The display apparatus of claim 5, wherein the number of frames of the frame period is equal to the number of the dither patterns.

7. The display apparatus of claim 2, wherein N is at least 2.

8. The display apparatus of claim 7, wherein the image signal comprises K least significant bits (LSBs), where K is a natural number, and the number of frames included in the first frame period is 2^{K}.

9. The display apparatus of claim 8, wherein the image signal controller changes an arrangement of the dither pixels of the dither patterns at every frame period.

10. The display apparatus of claim 9, wherein the image signal controller randomly changes the arrangement of the dither pixels of the dither patterns.

11. The display apparatus of claim 9, wherein the dither patterns are arranged in a unit of two adjacent dither patterns, and the image signal controller changes positions of the dither pixels of the two adjacent dither patterns for every frame period.

12. The display apparatus of claim 8, wherein the image signal controller comprises a frame counter configured to calculate a number of frames included in the frame period.

13. The display apparatus of claim 1, further comprising a dither memory configured to store the dither set corresponding to the dither level.

14. The display apparatus of claim 1, wherein the pixels are operated in a one-dot inversion method, a two-dot inversion method, or a column inversion method, within a frame.

15. The display apparatus of claim 1, wherein a number of the dither pixels is determined by the dither level, and each of the dither patterns determines the dither pixels.

16. The display apparatus of claim 15, wherein a sum of elements of the dither polarity matrix is zero.

17. The method of claim 16, wherein each row-polarity sum is the sum of elements in each row of the dither polarity matrix, and each column-polarity sum is the sum of elements in each column of the dither polarity matrix, and at least one of the sum of row-polarity sums and the sum of column-polarity sums is zero.

18. A display apparatus comprising:
a display panel comprising a dither block configured to display an image in response to a dither image signal, the dither block comprising pixels configured to be driven by polarity inversion during subsequent frames of an image; and
an image controller is configured to generate the dither image signal based on a received image signal by:
selecting dither patterns that correspond to a dither level of the received image signal, the dither patterns each corresponding to a dither polarity matrix, each element of the dither polarity matrix identifying which pixels of the dither block are dither pixels that are dithered during a corresponding frame of the image and a polarity of the dither pixels,
subsequently applying the dither patterns to the dither block at every frame period (including a plurality of frames), wherein, a combined matrix comprising the polarities of the dither pixels of the frame period is a zero matrix.
